(19) United States
(12) Patent Application Publication
(10) Pub. No.: US 2009/0090821 A1
(43) Pub. Date: Apr. 9, 2009

(54) CRADLE FOR AUTOMOBILE

(76) Inventors: Han Soo Kim, Seoul-si (KR); Youn Ui Jeong, Seoul-si (KR); Byung Mu Huh, Seoul-si (KR); Soung Hyun Lim, Anyang-si (KR)

Correspondence Address: BIRCH STEWART KOLASCH & BIRCH, PO BOX 747, FALLS CHURCH, VA, 22040-0747, US

(21) Appl. No.: 12/243,747

(22) Filed: Oct. 1, 2008

(30) Foreign Application Priority Data
Oct. 4, 2007 (KR) 10-2007-0099993

(51) Int. Cl. G12B 9/00

(52) U.S. Cl. 248/124.2

(57) ABSTRACT

The present invention relates to a cradle for an automobile. A cradle for an automobile according to the present invention comprises a mounting bracket having a front surface to which a device for an automobile is mounted; a link frame provided with a spherical head portion pivotally coupled to the mounting bracket so that the link frame is selectively folded with respect to a rear surface of the device; and a suction plate rotatably installed to a portion of the link frame opposite to a position on which the head portion is provided, the suction plate being selectively attached to a bottom surface. According to the present invention as described above, the cradle is carried or kept in a state where the cradle is folded with respect to the device. Thus, there is an advantage in that the overall volume of the cradle and device for an automobile is reduced.

### BACKGROUND OF THE INVENTION

1. Field of the Invention

The present invention relates to a cradle for an automobile, more particularly, to a cradle for an automobile to which every kind of device for an automobile used in an interior thereof by a driver is mounted.

2. Description of the Prior Art

In recent, devices for automobile such as a portable terminal having a digital multimedia broadcasting (DMB) function, a navigator providing a driver with the information regarding traffic conditions in real time, and the like have been developed rapidly. In particular, the aforementioned devices for an automobile are installed to an interior thereof to provide a driver with much information and entertainment. Accordingly, in order to allow a driver to obtain various kinds of information during a driving, a cradle for an automobile, which fixedly mounts a device for an automobile to an interior of an automobile, has been sold in the markets in large quantities, and development of the cradle has been accelerated.

FIG. 1 is a perspective view showing an external appearance of a conventional cradle for an automobile.

As shown in the figure, a cradle for an automobile is provided with a main body 2 for supporting a rear surface of a device for an automobile. A pair of supporters 4 are provided at a lower portion of the main body 2 and protrude forward from the main body 2. The supporters 4 are parts for supporting a lower surface of the device for an automobile.

In addition, pressing members 6 are provided at both sides of the main body 2, respectively. The pressing members 6 serve to press both side surfaces of the device for an automobile to support the device. The pressing members 6 are mounted so that at least one of the pressing members slides in the horizontal direction with respect to the main body 2. Accordingly, the pressing members 6 are freely adjusted according to a dimension of the device for an automobile to press both the side surfaces thereof. In addition, the pressing members 6 are not only slidably installed but also can slide in the horizontal direction by means of a coil spring provided in the main body 2.

In addition, sponges 8 are respectively provided on inner surfaces of the pressing members 6 to face each other. The friction between the sponge 8 and the device for an automobile causes the device not to slide downward. The sponge 8 is attached to the inner surface of the pressing member 6 through a double-sided tape.

In the meantime, a hose 10 is provided at one side of a rear surface of the main body 2 to extend rearward of the main body 2. The hose 10 can be freely bent according to the movement of the main body 2 and is connected to a suction member 12. The suction member 12 is a part by which the main body 2 is attached to an interior of an automobile.

In the conventional art having the aforementioned configuration, a user puts a device for an automobile on the main body 2 and slides the pressing members 6 inwardly so that the distance between the pressing members is the size of the device to fix it. At this time, the supporter 4 supports a lower surface of the device for an automobile. Then, the user operates an interface of the device to watch a program on a desired channel or obtain every kind of information.

However, the conventional cradle for an automobile according to the prior art as described above has a problem as follows.

Recently, automobiles in which devices for an automobile such as a navigator are mounted have been rapidly increased. In general, a navigator is mounted to an inner surface of a windshield of an automobile, so that men can easily see from the outside whether the navigator is mounted in the automobile or not. Due to the above configuration, larcenists who break a windshield of an automobile and steal a navigator mounted in an automobile are increased day by day. Such a problem has been recognized as the biggest trouble in United State as well as Europe.

As described above, in order to prevent the navigator from being stolen, the user separates the navigator and the cradle from the windshield after driving an automobile and then keeps them in a receiving box provided in the automobile or in a house. In the cradle for an automobile according to the prior art, however, since the main body 2 and the suction member 12 are connected to the hose 10, the cradle has a large volume which is in proportion to a distance between the main body and the suction member. Due to the large volume of the cradle for an automobile as described above, it is not easy to separate the cradle from an automobile and keep it safe.

Accordingly, since it is not easy to separate a large-volumed cradle for an automobile together with a navigator from a windshield and it is inconvenient to carry the cradle together with the navigator, there are instances where a driver leaves a navigator in an automobile, which ultimately results in theft of a navigator.

In addition, since the cradle for an automobile as described above has a large volume, a user separates the cradle from a navigator and keeps separately the cradle and the navigator, rather than keeping the cradle along with the navigator. Thus, there is a problem in that a user feels it inconvenient.

### SUMMARY OF THE INVENTION

The present invention is conceived to solve the above problems of the prior art as described above, an objective of the present invention is to provide a cradle for an automobile with a structure to have a small overall volume together with a device for an automobile when the cradle is detached from an automobile.

According to an aspect of the present invention for achieving the objects, there is a cradle for an automobile, which comprises a mounting bracket having a front surface to which a device for an automobile is mounted; a link frame provided with a spherical head portion pivotally coupled to the mounting bracket so that the link frame is selectively folded with respect to a rear surface of the device; and a suction plate rotatably installed to a portion of the link frame opposite to a position on which the head portion is provided, the suction plate being selectively attached to a bottom surface.

The link frame may be formed in the shape of a frame, and the suction plate may be rotatably installed inside of the link frame.

The suction plate may be rotatably installed on a rotational shaft provided in the link frame, and the rotational shaft may be provided with a locking lever for selectively restricting the rotation of the suction plate.

A bent neck portion may be provided on a side of the link frame to extend therefrom, and the head portion may be provided at a leading end of the neck portion.

The suction plate may comprise a suction member installed to be movable relatively to the suction plate and selectively attached to the bottom surface while a portion except a periphery is raised upward; and an operating lever provided to be rotatable within a certain angular range to thereby adjust the movement of the suction member relative to the suction plate.

Guide ribs, which are inserted into guide grooves formed on the rear surface of the device, may be provided at both sides of a front surface of the mounting bracket, respectively.

Several preferred embodiments of the present invention will be described in more detail below with reference to accompanying drawings, from which the characteristics and advantages of the present invention will become more apparent.

### BRIEF DESCRIPTION OF THE DRAWINGS

The above and other objects, features and advantages of the present invention will be more apparent after reading the following detailed description taken in conjunction with the accompanying drawings, in which:

FIG. 1 is a perspective view showing an external appearance of a general cradle for an automobile;

FIG. 2 is a perspective view showing a state where a device for an automobile is mounted to a cradle for an automobile according to a preferred embodiment of the present invention;

FIG. 3 is a perspective view showing a front external appearance of the cradle for an automobile according to the present invention;

FIG. 4 is a perspective view showing a rear external appearance of the cradle for an automobile according to the present invention;

FIG. 5 is a perspective view showing a state where the cradle according to the present invention is folded; and

FIGS. 6a to 6c are perspective views illustrating a process of fixing the cradle according to the present invention.

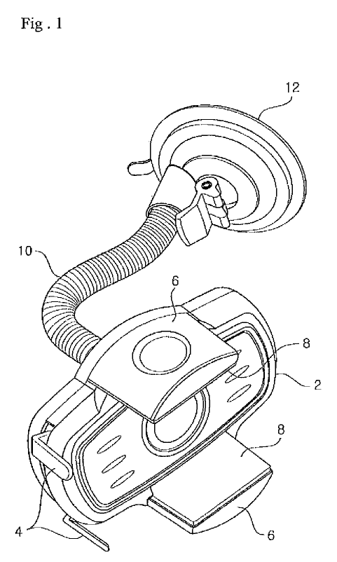

### DETAILED DESCRIPTION OF THE PREFERRED EMBODIMENTS

Hereinafter, a preferred embodiment of the present invention will be described in more detail with reference to the accompanying drawings. In the following description and drawings, the same reference numerals are used to designate the same or similar components.

Hereinafter; a preferred embodiment of a cradle for an automobile according to the present invention will be described in detail with reference to the accompanying drawings.

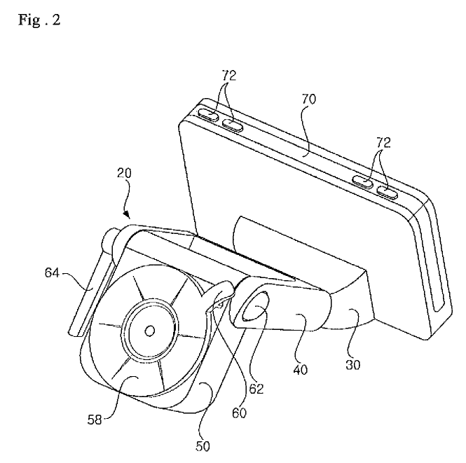

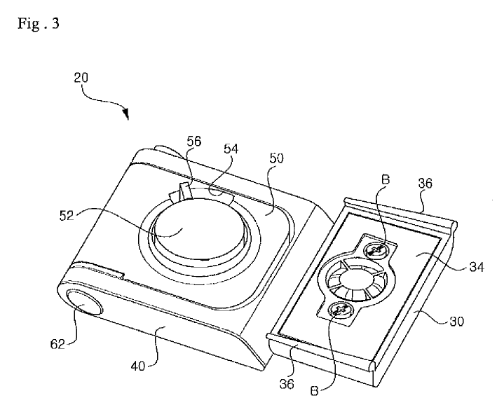

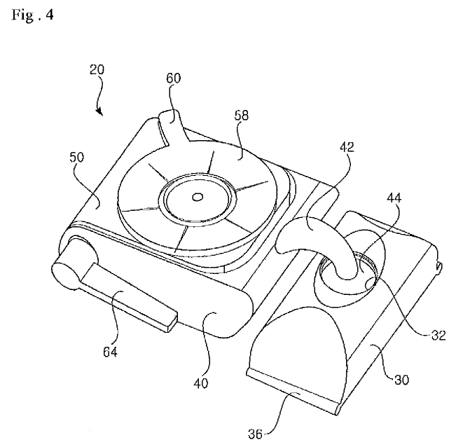

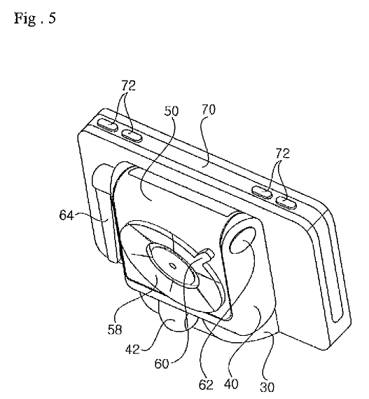

FIG. 2 is a perspective view showing a state where a device for an automobile is mounted to a cradle for an automobile according to a preferred embodiment of the present invention, FIG. 3 is a perspective view showing a front external appearance of the cradle for an automobile according to the present invention, FIG. 4 is a perspective view showing a rear external appearance of the cradle for an automobile according to the present invention, and FIG. 5 is a perspective view showing a state where the cradle according to the present invention is folded.

As shown in the figures, a cradle 20 for an automobile to be installed to an interior of an automobile is provided with a mounting bracket 30. The mounting bracket 30 is formed in the shape of an approximate plate and is a part to which a device 70 for an automobile is mounted.

The device 70 is mounted to a front surface of the mounting bracket 30, and a head coupling portion 32, to which a head portion 44 to be described later is pivotally coupled, is concavely formed on a back surface of the mounting bracket 30. The head coupling portion 32 has a concaved shape corresponding to the shape of the head portion 44 and is formed to partially cover the head portion 44.

Here, the head coupling portion 32 should be designed to meet the following conditions. First, in a state where the cradle 20 for an automobile is assembled, the head coupling portion should fasten the head portion 44 so that it can be rotated at a desired angle if a user applies a force thereto. In addition, the head coupling portion should also fasten the head portion 44 so that the mounting bracket 30 and the device 70 mounted thereto can be supported unless external force is exerted thereon after the bead portion 44 is rotated at a desired angle by a user.

In addition, a fixing plate 34 for fixing the head portion 44 to the head coupling portion 32 is coupled to a front surface of the mounting bracket 30. The fixing plate 34 is coupled to the mounting bracket 30 by means of a fastener such as a bolt B.

Meanwhile, guide ribs 36 are provided on both sides of a front surface of the mounting bracket 30, respectively. The guide ribs 36 are parts to be inserted into guide grooves 74 formed on a rear surface of the device 70 for an automobile. That is, the guide jibs 36 are guided along and inserted into the guide grooves 74 to thereby allow the device 70 for an automobile to be securely fixed to the mounting bracket 30.

A link frame 40, which is selectively folded with respect to a rear surface of the device 70 for an automobile, is coupled to the mounting bracket 30. The link frame 40 is pivotally coupled to the mounting bracket 30 in order to secure various viewing angles. The link frame 40 has a structure formed in the shape of a frame, wherein an inside of the link frame 40 is opened so that a suction plate 50 to be described later can be rotated therein. In this embodiment the link frame 40 is formed in an approximate [symbol] shape by an injection molding process.

In addition, a neck portion 42 is provided on one side of the link frame 40 to extend therefrom. The neck portion 42 has a bent shape so that the link frame 40 is rotated and comes into contact with the rear surface of the device 70. The spherical head portion 44 is provided at a leading end of the neck portion 42. The head portion 44 has a diameter relatively lager than that of the neck portion 42 and is pivotally coupled to the head coupling portion 32.

The suction plate 50 is rotatably installed to a portion of the link frame 40 opposite to the position on which the head portion 44 is provided. The suction plate 50 is rotatably installed through a rotational shaft 62 to be described later. The suction plate 50 is rotatably installed to the inside of the link frame 40 having a frame shape. The suction plate 50 is a part fixed to an interior of an automobile. In a state where the suction plate 50 is fixed to a windshield or the like, a user can rotate the mounting bracket 30 in forward, backward, left and right directions to observe the device 70 at a desired angle.

A button 52 is provided on the suction plate 50. The button 52 is a portion that is manipulated by a user to fix the suction plate 50 to the interior.

A lever groove 54 is concavely formed on the suction plate 50. The lever groove 54 is formed in the4 shape of a circular arc having a certain central angle. An operating lever 56 is provided in the lever groove 56 to be rotatable within a certain angular range. The operating lever 56 serves to adjust a relative movement of a suction member 58 to be described later. Accordingly, if a user rotates the operating lever 56, the suction member 58 is moved relatively to the suction plate 50 to be attached to or released from a bottom surface.

A release handle 60 is provided at one side of an edge of the suction member 58. The release handle 60 lifts one side of the suction member 58 in a suction releasing state of the suction member 58 to thereby remove remaining suction force, thereby serving to completely detach the suction member 5 9 from the bottom surface.

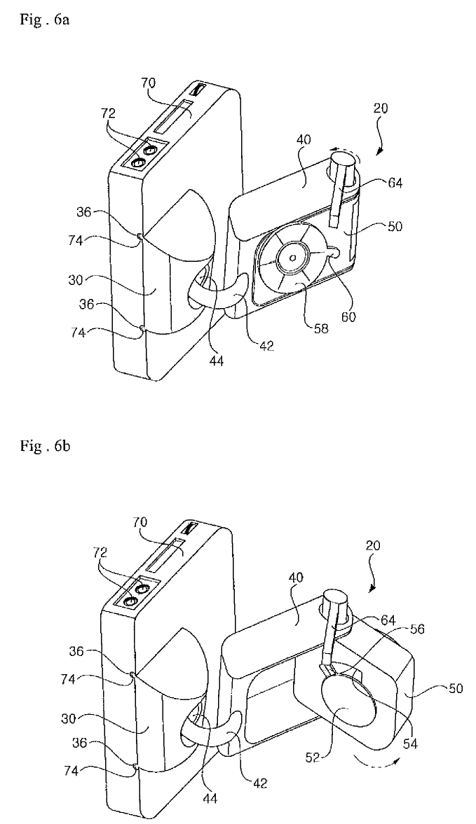

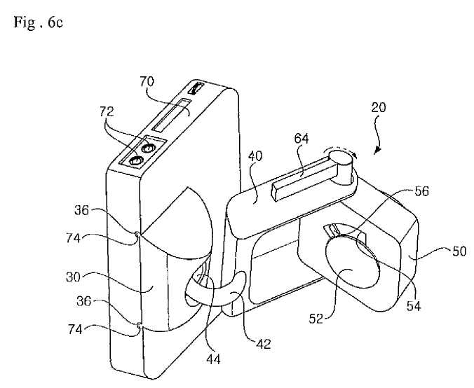

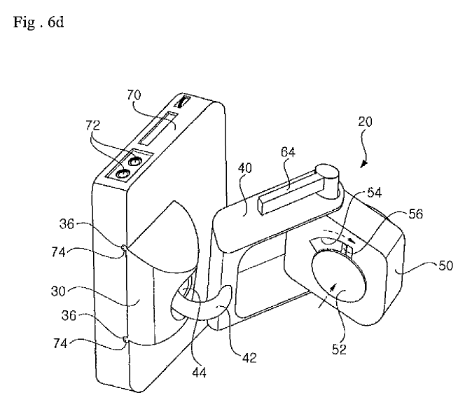

The suction plate 50 is installed to be rotatable about the rotational shaft 62 passing through an end of the link frame 40. A locking lever 64 is provided at one side of the rotational shaft 62. The locking member 64 is to control the rotation of the suction plate 50. That is, as shown in FIG. 4, if the locking lever 64 is in a state where the locking lever is parallel with the link frame 40, the suction plate 50 becomes a locking state, whereby it cannot be rotated. In addition, if the locking lever 64 is rotated as shown in FIG. 6a, the suction plate 50 becomes a release state, whereby it can be rotated.

The rotational shaft 62 operated as described above can be configured to have not a circular cross section but an elliptical cross section, so that the suction plate 50 can be locked or released according to a rotational angle of the rotational shaft. With the aforementioned configuration, it is possible to control the rotation of the suction plate 50 and fix it at a desired location.

In the meantime, the mounting bracket 30 is mounted with the device 70, such as a navigator, a digital multimedia broadcasting (DMB) terminal or the like. The device 70 has an approximately flat rectangular hexahedral shape. A plurality of operation buttons 72 are provided in an upper end of the device 70 to operate the device 70. The pair of guide grooves 74 (see FIG. 6a) are provided in parallel on the rear surface of the device 70. The guide ribs 36 are received and guided in the guide grooves 74. A jack connecting portion 76 into which an earphone jack can be inserted is formed on a side surface of the device 70 for an automobile.

Hereinafter, the operation and function of the cradle for an automobile according to the present invention having the above configurations will be described in detail.

First, a process of attaching the cradle 20 for an automobile to a windshield of an automobile will be described. FIGS. 6a to 6c are perspective views illustrating a process for fixing the cradle according to the present invention.

According to the figures, a user grasps the link frame 40 by hand and rotates it at a desired angle as shown in FIG. 6a. At this time, the link frame 40 will be rotated about the head portion 44. Then, the user rotates the locking lever 64 in the arrow direction to release a locking state of the suction plate 50. That is, if a locking state of the suction plate 50 is released, the suction plate 50 becomes a state where the suction plate can be rotated about rotational shaft 62.

Next, the user rotates the suction plate 50 to a desired orientation in the arrow direction (FIG. 6b). Then, the user rotates again the locking lever 64 in the arrow direction as shown in FIG. 6c to enable the suction plate 50 to be locked in a rotated state.

Finally, the user positions the suction member 58 on a desired location of a windshield of an automobile and then rotates the operating lever 54 in the arrow direction in a state where the button 56 is pressed (FIG. 6d). Then, a central portion of the suction member 58 except a periphery region is raised upward and then the suction member is attached to the windshield by suction force. That is, in the process of rotating the operating lever 50, the central portion of the suction member 58 overcomes elastic force of an elastic member provided in the suction plate 50, and the suction plate 58 is attached to the windshield.

As described above, in order to release the attached state of the cradle 20 fixed to the windshield, the operating lever 50 is rotated in the opposite direction. Then, the central portion of the suction member 58 is lowered by the elastic force of the elastic member and the suction member is restored to its original state. In addition, if the user grasps and then lifts the release handle 60, the cradle 20 for an automobile is detached lo from the windshield.

In addition, in a state where the cradle 20 is fixed, the user rotates the link frame 40 or adjusts the locking lever 64 to rotate the suction plate 50, so that a desired viewing angle of the cradle 20 can be secured.

Through the aforementioned process, the cradle 20 for an automobile can be freely attached to and detached from a windshield of automobile. Accordingly, after driving, the user detaches the cradle 20 from the windshield as described above in order to prevent the cradle 20 from being stolen.

Next, the user rotates the locking lever 64 to release a locking state of the suction plate 50 and rotates the suction plate 50 to be positioned inside of the link frame 40. If the suction plate 50 is positioned inside of the link frame 40, the user rotates the locking lever 64 again to make the suction plate 50 in a locking state. Then, the user grasps and rotates the link frame 40 to make the link frame 40 and suction plate 50 be in contact with the rear surface of the device 70 for an automobile. Such a state is well shown in FIG. 5.

As described above, if the suction plate 50 is folded with respect to the rear surface of the device 70, the cradle 20 and the device 70 has a compact external appearance as well known from FIG. 5. That is, as compared with a conventional cradle for an automobile, an overall thickness of the cradle 20 and device 70 for an automobile become small. Thus, the user conveniently carries the cradle for an automobile. In addition, when the cradle 20 is folded with respect to the device 70, the overall volume of the cradle 20 and device 70 is small, so that it is easy to keep the cradle 20 and device 70 in a separate receiving box provided in an automobile.

In the present invention, the suction plate is constructed such that the suction plate is folded and comes in contact with a rear surface of the device for an automobile together with the link frame. Accordingly, in a state where the device for an automobile is mounted to the cradle for an automobile, if the cradle for an automobile is detached from a windshield and the suction plate is folded, an overall volume is reduced. As a result in a state where the device and the cradle for an automobile are detached, the user can carry and keep more conveniently the device and the cradle for an automobile. As described above, since the user can separate and keep the device and the cradle for an automobile more positively, there is an advantage in that a theft of the device for an automobile is prevented.

The present invention is configured so that the suction plate, together with the link frame, is folded with respect to the rear surface of the device for an automobile. Accordingly, in a state where the device is mounted to the cradle, after the cradle is detached from a windshield, the suction plate is folded thereby decreasing the overall volume of the cradle. Consequently, in a state where the device and cradle for an automobile are separated, a user can conveniently carry or keep the cradle and device for an automobile. As described above, since the user can separate and keep the device and cradle for an automobile more actively, there is an advantage that the device for an automobile is prevented from being stolen.

Although several preferred embodiments of the present invention have been disclosed for illustrative purposes, it should be understood that numerous modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art,

What is claimed is:

1. A cradle for an automobile, comprising:
a mounting bracket having a front surface to which a device for an automobile is mounted;
a link frame provided with a spherical head portion pivotally coupled to the mounting bracket so that the link frame is selectively folded with respect to a rear surface of the device; and
a suction plate rotatably installed to a portion of the link frame opposite to a position on which the head portion is provided, the suction plate being selectively attached to a bottom surface,

2. The cradle claimed in claim 1, wherein the link frame is formed in the shape of a frame, and the suction plate is rotatably installed inside of the link frame.

3. The cradle claimed in claim 2, wherein the suction plate is rotatably installed on a rotational shaft provided in the link frame, and the rotational shaft is provided with a locking lever for selectively restricting the rotation of the suction plate.

4. The cradle claimed in claim 3, wherein a bent neck portion is provided on a side of the link frame to extend therefrom, and the head portion is provided at a leading end of the neck portion.

5. The cradle claimed in any one of claims 1 to 4, wherein the suction plate comprises a suction member installed to be movable relatively to the suction plate and selectively attached to the bottom surface while a portion except a periphery is raised upward; and an operating lever provided to be rotatable within a certain angular range to thereby adjust the movement of the suction member relative to the suction plate.

6. The cradle claimed in claim 5, wherein guide ribs, which are inserted into guide grooves formed on the rear surface of the device, are provided at both sides of a front surface of the mounting bracket, respectively.
